(19) United States
(12) Patent Application Publication
(10) Pub. No.: US 2017/0048140 A1
(43) Pub. Date: Feb. 16, 2017

(54) DYNAMIC LSP RESIZING IN A GMPLS MESH NETWORK

(71) Applicant: Infinera Corporation, Annapolis Junction, MD (US)

(72) Inventors: Ravi PANDEY, Bangalore (IN); Saurabh PANDEY, Bangalore (IN); Abhijit KULKARNI, Bangalore (IN)

(21) Appl. No.: 14/871,255

(22) Filed: Sep. 30, 2015

(30) Foreign Application Priority Data
Aug. 14, 2015 (IN) 4235/CHE/2015

(51) Int. Cl. H04L 12/721; H04L 12/26; H04L 12/723

(52) U.S. Cl. CPC H04L 45/70; H04L 45/50; H04L 43/0882

(57) ABSTRACT

A method to dynamically resize an LSP without releasing it includes: establishing a first path through a network from a first device to a second device; receiving a request to resize the first path; establishing a second path identical to the first path; simultaneously transmitting communication signals on the first path and the second path; and switching all communication signals from the first path to the second path.

### CLAIM OF PRIORITY UNDER 35 U.S.C. §119

The present Application for Patent claims priority to Provisional Application No. 4235/CHE/2015 entitled “Dynamic LSP Resizing in a GMPLS Mesh Network” filed Aug. 14, 2015, and assigned to the assignee hereof and hereby expressly incorporated by reference herein.

### FIELD OF DISCLOSURE

This disclosure relates generally to communication networks and more specifically, but not exclusively, to resizing a data path in a communication network.

### BACKGROUND

Conventional communications networks, such as telecommunications networks, can use a variety of protocol to transport data across the network. One such protocol is MultiProtocol Label Switching (MPLS). MPLS is a mechanism for routing traffic within a telecommunications network, as data travels from one network node to the next. MPLS can provide applications including VPNs (Virtual Private Networks), traffic engineering (TE) and Quality of Service (QoS). In MPLS, packets are directed through the network based on an assigned label. The label is associated with a predetermined path through the network, which allows a higher level of control than in packet-switched networks. MPLS routing allow differing QoS characteristics and priorities to be assigned to particular data flows, and operators can predetermine fallback paths in the event that traffic must be rerouted.

With pure IP (Internet Protocol) routing in a packet-switched network, each data packet could determine its own path through the network—which was a dynamic flow, but not predictable. However, it was very cost effective. In previous circuit-switched telecom networks, physical wires and T1 lines carried data and voice traffic. That provided predictable routes, but was very expensive and difficult to scale because of the need to put in extensive infrastructure. So MPLS evolved to allow control of network routing, creating paths that act like a point-to-point connection within the network, but are virtual and flexible instead of physical.

As packets travel through the MPLS network, their labels are switched or swapped. The packet enters the edge of the MPLS backbone, is examined, classified and given an appropriate label, and forwarded to the next hop in the pre-set Label Switched Path (LSP). As the packet travels that path, each router (or switch) on the path uses the label—not other information, such as the IP header—to make the forwarding decision that keeps the packet moving along the LSP. However, within each router, the incoming label is examined and its next hop is matched with a new label. The old label is replaced with the new label for the packet's next destination, and then the freshly labeled packet is sent to the next router. Each router repeats the process until the packet reaches an egress router. The label information is removed at either the last hop or the exit router, so that the packet goes back to being identified by an IP header instead of an MPLS label.

In current communication networks, once a LSP is created, the LSP rate cannot be changed. To resize the LSP, the available option is to delete the existing LSP and create a new one at the desired rate. This operation temporarily shuts down the LSP traffic and impacts the overall traffic for the customer. The need to resize an LSP is generated from many causes. For example, in an optical transport network (OTN), an optical data unit (ODU) is the transport container for client signals. For ODUFlex services, clients often need to change the long haul bandwidth depending on service aggregation and port consolidation. This may require resizing the LSP. In another example, with packet services, new services addition and deletion happen frequently. If resizing is not performed, the fixed amount of bandwidth (BW) will waste network resource unnecessarily. In another example, a client may require different BW during the day versus at night.

Accordingly, there is a need for systems, apparatus, and methods that improve upon conventional approaches including the improved methods, system and apparatus provided hereby.

### SUMMARY

The following presents a simplified summary relating to one or more aspects and/or examples associated with the apparatus and methods disclosed herein. As such, the following summary should not be considered an extensive overview relating to all contemplated aspects and/or examples, nor should the following summary be regarded to identify key or critical elements relating to all contemplated aspects and/or examples or to delineate the scope associated with any particular aspect and/or example. Accordingly, the following summary has the sole purpose to present certain concepts relating to one or more aspects and/or examples relating to the apparatus and methods disclosed herein in a simplified form to precede the detailed description presented below.

In one aspect, a method to dynamically resize an LSP without releasing it includes: a first LSP having a tunnel; establishing a new tunnel (Resized-Tunnel or R-Tunnel) along the same path of existing tunnel (or E-Tunnel) and by sharing the time division multiplexing timeslots (TDM slots) along the path of the existing tunnel. Depending on the rate requirement of the new LSP versus the first LSP, timeslots are added or subtracted. Unlike conventional approaches, the E-Tunnel remains active until the traffic is switched to the R-Tunnel. Once the R-Tunnel is setup, traffic is switched to R-Tunnel. Upon successful transition to R-Tunnel, the E-Tunnel is deleted. Also, the end to end path of the LSP does not change.

Other features and advantages associated with the apparatus and methods disclosed herein will be apparent to those skilled in the art based on the accompanying drawings and detailed description.

### BRIEF DESCRIPTION OF THE DRAWINGS

A more complete appreciation of aspects of the disclosure and many of the attendant advantages thereof will be readily obtained as the same becomes better understood by reference to the following detailed description when considered in connection with the accompanying drawings which are presented solely for illustration and not limitation of the disclosure, and in which:

FIG. 1 illustrates an exemplary high level process flow involved in resize of an LSP in accordance with some examples of the disclosure.

FIG. 2 illustrates an exemplary flow diagram showing the state machine changes for a signaling control module (SCM) module in accordance with some examples of the disclosure.

FIG. 3 illustrates an exemplary algorithm to compute new timeslots in CAC in accordance with some examples of the disclosure.

FIG. 4 illustrates an exemplary path diagram in accordance with some examples of the disclosure.

In accordance with common practice, the features depicted by the drawings may not be drawn to scale. Accordingly, the dimensions of the depicted features may be arbitrarily expanded or reduced for clarity. In accordance with common practice, some of the drawings are simplified for clarity. Thus, the drawings may not depict all components of a particular apparatus or method. Further, like reference numerals denote like features throughout the specification and figures.

### DETAILED DESCRIPTION

The exemplary methods, apparatus, and systems disclosed herein advantageously address the industry needs, as well as other previously unidentified needs, and mitigate shortcomings of the conventional methods, apparatus, and systems. For example, one method defines a systematic process to resize (increase and decrease the size of) an existing LSP in generalized MPLS mesh network. This example uses a packet optical transport capable switch, but it is applicable to all transport network switches that demand variable rate service. The LSP defined here is assumed to be a ODU-Flex type. LSP's are setup with a certain ODU Flex rate between two devices (such as network elements (NEs) in a GMPLS mesh network and can transit via multiple NEs). The rate of an LSP is defined in terms of timeslots (TDM slots) it requires to carry the user traffic from ingress NE to the egress NE in communication networks. The trigger to initiate this procedure can be a user driven operation or, by dynamic detection for change of rate. In this example, we are assuming dynamic rate change detection depending on interface utilization factor. Thus, if an Ethernet interface utilization factor is more than 90%, a device can be required for increasing the BW to GMPLS module. Due to the forwarding of packets through an LSP being opaque to higher network layers, an LSP is also sometimes referred to as an MPLS tunnel. The router which first prefixes the MPLS header to a packet is called an ingress router. The last router in an LSP, which pops the label from the packet, is called an egress router. Routers in between, which need only swap labels, are called transit routers or label switch routers (LSRs).

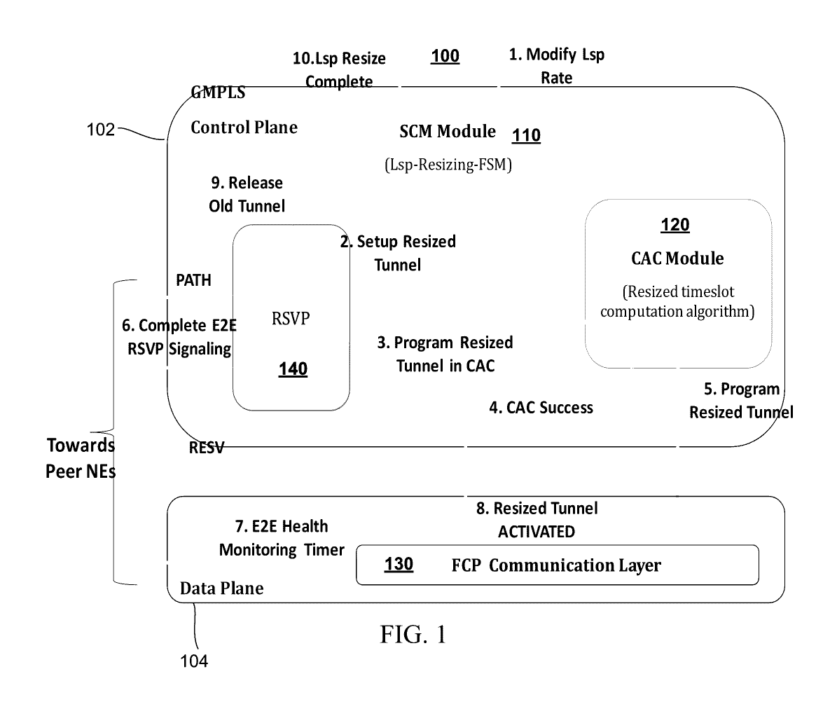

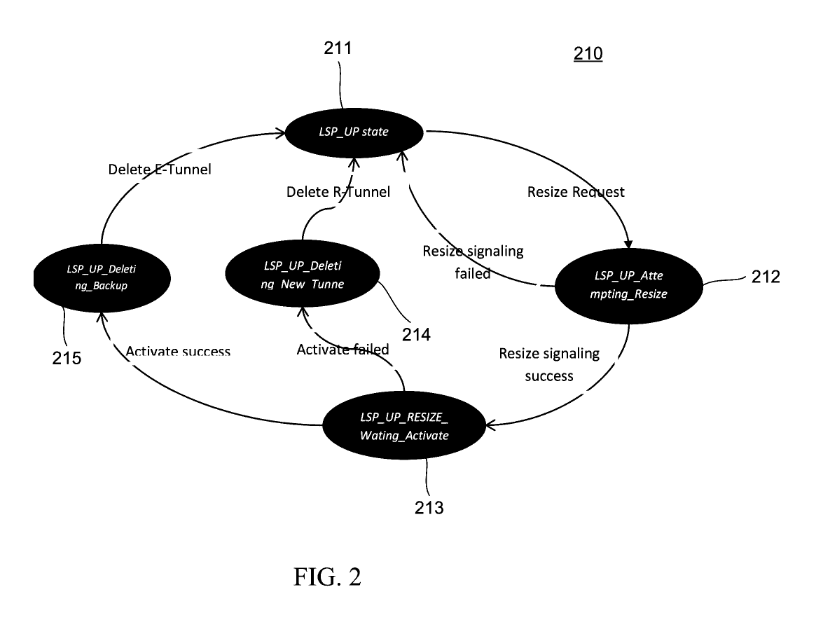

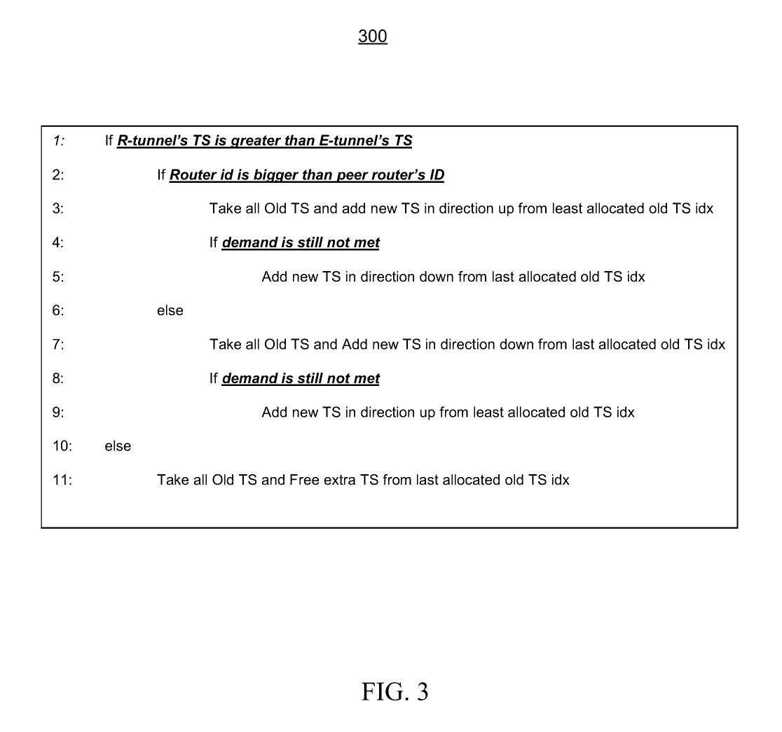

FIG. 1 illustrates the high level flow of process 100 involved in resize of an LSP. First, a trigger to resize an existing LSP is received by a first device (e.g. ingress NE), a new state machine in a SCM 110 is triggered to setup a new tunnel in the same LSP. This new tunnel (R-Tunnel) will be using the same path of the existing LSP (E-Tunnel). Second, the SCM 110 sends a signal RSVP module 140, and RSVP module will in turn signal to the connection admission control (CAC) module 120 to inform the CAC 120 to use the same timeslots as used by the by E-Tunnel, and also might allocated a new set of timeslots if the R-Tunnel is of a higher rate than E-Tunnel. The timeslots of R-Tunnel could be more or less than what the E-Tunnel used. FIG. 2 illustrate a flow diagram showing the state machine changes for SCM 110. FIG. 3 illustrates one example algorithm to compute new timeslots in CAC module 120 and is discussed below.

For example, both the first device and the second device allocate the time slots in different directions to avoid collision of time slots between two connections from opposite sides. If the R-tunnel demands an increased rate, the E-tunnel's time slots are re-used and more are added for the forward or reverse direction. If the new LSP demands a reduced rate or less time slots, the old tunnel's time slots are re-used and the extra starting from last time slots are freed. Third, once the CAC module 120 succeeds in allocating new timeslots, it will inform back to the RSVP 140 to signal the re-sized LSP along the path of original tunnel (e.g. via Resource Reservation Protocol-Traffic Engineering (RSVP TE)). Fourth, the CAC module 120 informs the network's control plane (e.g. fast control plane (FCP)) 130 to program the shared tunnel. Fifth, the SCM 110 sends an event/signal to the RSVP-TE 140 to initiate setup of the new resized LSP (R-Tunnel) end to end. Sixth, at each transit device or NE (e.g. LSR), the CAC module 120 does the same until it reaches the second device (egress node) of the LSP and completes the RSVP signaling by sending an acknowledgement (e.g. RESV) back to first device (ingress node). At this point, SCM 110 completes the first phase of FSM declaring the setup of resized tunnel.

Seventh, once the resized LSP (R-Tunnel) is setup end to end in the control plane 102 and the data plane 104, data plane 104 in conjunction with the FCP communication layer 130 monitors the health of the R-Tunnel from end to end for some period of time before it declares it usable. For example, a health check timer may be started. The duration of this timer could be any configuration, but for simplicity we assume 60 seconds. Once the timer expires, the health of resized Tunnel is declared well in the data plane 104 as long as not problems were detected. The data plane 104 makes a switch from original Tunnel (E-Tunnel) to resized Tunnel (R-Tunnel) in the data plane 104 end to end along the path of tunnel. This switch may be in 50 ms and may use the FastSMP architecture. Eighth, when this is completed, a “Tunnel LSP” event is posted to control plane 102. Ninth, on receiving this event notice, the control plane 102 in conjunction with the SCM 110 initiates deletion of original tunnel (E-Tunnel) via RSVP 140. Tenth, once existing tunnel is deleted end to end, the SCM 110 declares the completion of the resize of LSP. Now the first and second device can start feeding the traffic with new rate.

Referring to FIG. 2, the state machines for an SCM 210 will be described. The SCM 210 may start in a LSP up state 211 (an existing LSP has been set up). Upon receipt of a resizing request, the SCM 210 moves to a LSP up attempt resizing state 212. From here, one of two events will follow the attempt to resize the LSP. In one instance, the attempt failed and the SCM 210 moves back to state 211. Otherwise, the resize attempt is successful and the SCM 210 moves to a LSP up resize waiting for activate state 213. From here, one of two events will follow. The activation will fail and the SCM 210 will move to a LSP up deleting new tunnel state 214 (activation failed) or a LSP up deleting backup state 215 (activation successful). After deleting the R-tunnel if activation fails (state 214) or deleting the E-tunnel if activation is successful, the SCM 210 returns to the LSP up state 211.

Referring to FIG. 3, an exemplary algorithm 300 to compute new timeslots in the CAC module 120 is shown. As shown, the algorithm 300 first starts with determining if the R-tunnels time slots are greater than the E-tunnel's time slots. Next, the algorithm 300 determines if the first device's identification (ID) is bigger than the second device's ID. Next, the algorithm 300 takes all the old time slots and adds new time slots in a direction up from the least allocated old time slot. Next, the algorithm 300 determines if the demand for time slots has not been met. If not, the algorithm 300 adds new time slots in a direction down from the last allocated old time slot. Otherwise, the algorithm 300 takes all the old time slots and adds new time slots in direction down from the last allocated old time slots. Next, the algorithm 300 determines if the demand for time slots has not been met. If not, the algorithm 300 adds new time slots in direction up from least allocated old time slots. Otherwise, the algorithm 300 ends. If the first R-tunnel's timeslots are less than E-tunnel's timeslots, the algorithm 300 takes all the old timeslots and free the extra timeslots from last allocated leaving the required timeslots for new tunnel.

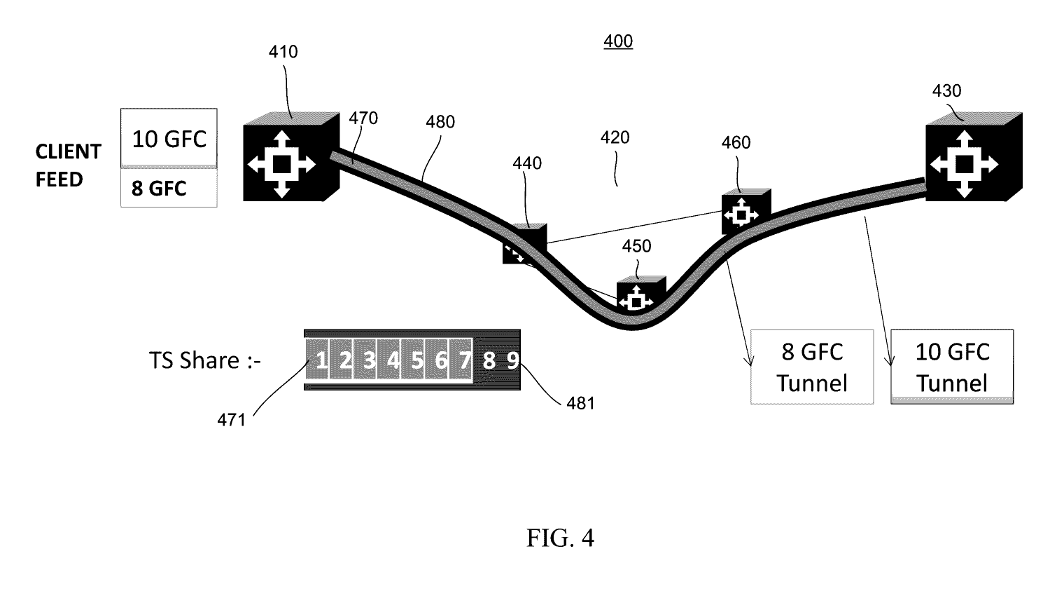

In one example shown in FIG. 4, a system 400 for rate adaption of an existing LSP in a network may resize the existing LSP with no or minimal impact to the existing traffic. As shown in FIG. 4, a system 400 may include a first device 410 (e.g. an ingress router or switch) connected to a network 420 (e.g. a MPLS network) and a second device 430 (e.g. an egress router or switch) also connected to the network 420. The network 420 may include a third device 440 (e.g. a NE such as a transit router or switch), a fourth device 450 (e.g. a NE such as a transit router or switch), and a fifth device 460 (e.g. a NE such as a transit router or switch) connected together with multiple paths such as a mesh network for the transport of communication signals across the network 420. As shown, a first path 470 (e.g. a LSP tunnel) may be established from the first device 410 through the network 420 to the second device 430. This first path may be an 8 GB fibre channel (GFC) that uses eight time slots 471 (e.g. slots 0-7). In one example, the system 400 receives a request to resize the first path 470 from 8 GFC to 10 GFC that uses ten time slots 481. The system 400 may establish a second path 480 that follows the first path 470 through the network 420 from the first device 410 to the second device 430. In operation as described above, the system 400 may establish the second path 480 before deleting or removing the first path 470 and simultaneously transmit communication signals between the first device 410 and the second device 430 until the second path 480 is verified as stable, following which the system 400 will move all communications signals to the second path 480 and delete or remove the first path 470.

The word “exemplary” is used herein to mean “serving as an example, instance, or illustration.” Any details described herein as “exemplary” is not necessarily to be construed as preferred or advantageous over other examples. Likewise, the term “examples” does not require that all examples include the discussed feature, advantage or mode of operation. Use of the terms “in one example,” “an example,” “in one feature,” and/or “a feature” in this specification does not necessarily refer to the same feature and/or example. Furthermore, a particular feature and/or structure can be combined with one or more other features and/or structures. Moreover, at least a portion of the apparatus described hereby can be configured to perform at least a portion of a method described hereby.

The terminology used herein is for the purpose of describing particular examples only and is not intended to be limiting of examples of the disclosure. As used herein, the singular forms “a,” “an,” and “the” are intended to include the plural forms as well, unless the context clearly indicates otherwise. It will be further understood that the terms “comprises”, “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should be noted that the terms “connected,” “coupled,” or any variant thereof, mean any connection or coupling, either direct or indirect, between elements, and can encompass a presence of an intermediate element between two elements that are “connected” or “coupled” together via the intermediate element.

Any reference herein to an element using a designation such as “first,” “second,” and so forth does not limit the quantity and/or order of those elements. Rather, these designations are used as a convenient method of distinguishing between two or more elements and/or instances of an element. Thus, a reference to first and second elements does not mean that only two elements can be employed, or that the first element must necessarily precede the second element. Also, unless stated otherwise, a set of elements can comprise one or more elements.

Further, many examples are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects of the disclosure may be embodied in a number of different forms, all of which have been contemplated to be within the scope of the claimed subject matter. In addition, for each of the examples described herein, the corresponding form of any such examples may be described herein as, for example, “logic configured to” perform the described action.

Nothing stated or illustrated depicted in this application is intended to dedicate any component, step, feature, benefit, advantage, or equivalent to the public, regardless of whether the component, step, feature, benefit, advantage, or the equivalent is recited in the claims.

Further, those of skill in the art will appreciate that the various illustrative logical blocks, modules, circuits, and algorithm steps described in connection with the examples disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The methods, sequences and/or algorithms described in connection with the examples disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor.

The various illustrative logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or any other such configuration).

Although some aspects have been described in connection with a device, it goes without saying that these aspects also constitute a description of the corresponding method, and so a block or a component of a device should also be understood as a corresponding method step or as a feature of a method step. Analogously thereto, aspects described in connection with or as a method step also constitute a description of a corresponding block or detail or feature of a corresponding device. Some or all of the method steps can be performed by a hardware apparatus (or using a hardware apparatus), such as, for example, a microprocessor, a programmable computer or an electronic circuit. In some examples, some or a plurality of the most important method steps can be performed by such an apparatus.

In the detailed description above it can be seen that different features are grouped together in examples. This manner of disclosure should not be understood as an intention that the claimed examples require more features than are explicitly mentioned in the respective claim. Rather, the situation is such that inventive content may reside in fewer than all features of an individual example disclosed. Therefore, the following claims should hereby be deemed to be incorporated in the description, wherein each claim by itself can stand as a separate example. Although each claim by itself can stand as a separate example, it should be noted that—although a dependent claim can refer in the claims to a specific combination with one or a plurality of claims—other examples can also encompass or include a combination of said dependent claim with the subject matter of any other dependent claim or a combination of any feature with other dependent and independent claims. Such combinations are proposed herein, unless it is explicitly expressed that a specific combination is not intended. Furthermore, it is also intended that features of a claim can be included in any other independent claim, even if said claim is not directly dependent on the independent claim.

It should furthermore be noted that methods disclosed in the description or in the claims can be implemented by a device comprising means for performing the respective steps or actions of this method.

Furthermore, in some examples, an individual step/action can be subdivided into a plurality of sub-steps or contain a plurality of sub-steps. Such sub-steps can be contained in the disclosure of the individual step and be part of the disclosure of the individual step.

While the foregoing disclosure shows illustrative examples of the disclosure, it should be noted that various changes and modifications could be made herein without departing from the scope of the disclosure as defined by the appended claims. The functions, steps and/or actions of the method claims in accordance with the examples of the disclosure described herein need not be performed in any particular order. Additionally, well-known elements will not be described in detail or may be omitted so as to not obscure the relevant details of the aspects and examples disclosed herein. Furthermore, although elements of the disclosure may be described or claimed in the singular, the plural is contemplated unless limitation to the singular is explicitly stated.

What is claimed is:

1. A method for establishing a communication path, the method comprising:
establishing a first path having a first rate through a network between a first device and a second device, the network configured for multiprotocol label switching;
transmitting communication signals designated for the first path on the first path at the first rate;
establishing a second path having a second rate through the network between the first device and the second device;
transmitting the communication signals designated for the first path on the first path at the first rate and on the second path at the second rate;
releasing the first path; and
transmitting the communication signals designated for the first path on the second path at the second rate.

2. The method of claim 1, further comprising receiving a request for the second rate.

3. The method of claim 1, wherein the establishing the second path further comprises:
determining if a number of second path time slots are greater than a number of first path time slots; and
adding a first new time slot logically above a last time slot of the number of first path time slots if the number of second path time slots is greater than a number of first path time slots.

4. The method of claim 3, wherein the establishing the second path further comprises:
determining if a demand for time slots has been met by the first new time slot; and
adding a second new time slot logically above the first new time slot if the demand for time slots has not been met.

5. An apparatus comprising:
means for establishing a first path having a first rate through a network between a first device and a second device, the network configured for multiprotocol label switching;
means for transmitting communication signals designated for the first path on the first path at the first rate;
means for establishing a second path having a second rate through the network between the first device and the second device;
means for transmitting the communication signals designated for the first path on the first path at the first rate and on the second path at the second rate;
means for releasing the first path; and
means for transmitting the communication signals designated for the first path on the second path at the second rate.

6. The apparatus of claim 5, further comprising means for receiving a request for the second rate.

7. The apparatus of claim 1, wherein the means for establishing the second path further comprises:
means for determining if a number of second path time slots are greater than a number of first path time slots; and
means for adding a first new time slot logically above a last time slot of the number of first path time slots if the number of second path time slots is greater than a number of first path time slots.

8. The apparatus of claim 7, wherein the means for establishing the second path further comprises:
means for determining if a demand for time slots has been met by the first new time slot; and
means for adding a second new time slot logically above the first new time slot if the demand for time slots has not been met.

9. A method for establishing a communication path, the method comprising:
establishing a first path having a first rate through a network between a first device and a second device, the network configured for multiprotocol label switching;
allocating a first plurality of time slots to the first path;
receiving a request for a second rate higher than the first rate;
establishing a second path at the second rate identical to the first path;
allocating a second plurality of time slots to the second path;
transmitting communication signals designated for the first path on the first path in the first plurality of time slots and in the second plurality of time slots;
allocating the first plurality of time slots to the second path;
releasing the first path; and
transmitting the communication signals designated for the first path on the second path at the second rate in the first plurality of time slots and the second plurality of time slots.

10. The method of claim 9, further comprising receiving a request for the second rate.

11. The method of claim 9, wherein the allocating the second plurality of time slots to the second path further comprises adding a first new time slot logically above a last time slot of the first plurality of time slots.

12. The method of claim 11, wherein the allocating the second plurality of time slots to the second path further comprises:
determining if a demand for time slots has been met by the first new time slot; and
adding a second new time slot logically above the first new time slot if the demand for time slots has not been met.

13. A non-transient computer readable medium containing program instructions for causing a processor to perform a process comprising:
establishing a first path having a first rate through a network between a first device and a second device, the network configured for multiprotocol label switching;
allocating a first plurality of time slots to the first path;
receiving a request for a second rate higher than the first rate;
establishing a second path at the second rate identical to the first path;
allocating a second plurality of time slots to the second path;
transmitting communication signals designated for the first path on the first path in the first plurality of time slots and in the second plurality of time slots;
allocating the first plurality of time slots to the second path;
releasing the first path; and
transmitting the communication signals designated for the first path on the second path at the second rate in the first plurality of time slots and the second plurality of time slots.

14. The non-transient computer readable medium of claim 13, further comprising receiving a request for the second rate.

15. The non-transient computer readable medium of claim 13, wherein the allocating the second plurality of time slots to the second path further comprises adding a first new time slot logically above a last time slot of the first plurality of time slots.

16. The method of claim 15, wherein the allocating the second plurality of time slots to the second path further comprises:
determining if a demand for time slots has been met by the first new time slot; and
adding a second new time slot logically above the first new time slot if the demand for time slots has not been met.
